(19) United States
(12) Patent Application Publication
(10) Pub. No.: US 2018/0056401 A1
(43) Pub. Date: Mar. 1, 2018

(54) Adjustable Chuck Apparatus for Screw Tap

(71) Applicant: Yu-Chieh Lin, Taichung City (TW)

(72) Inventor: Yu-Chieh Lin, Taichung City (TW)

(21) Appl. No.: 15/246,610

(22) Filed: Aug. 25, 2016

(51) Int. Cl. B23B 31/10; B23B 31/20

(52) U.S. Cl. CPC B23B 31/102; B23B 31/202; B23B 2231/54; B23B 2231/2043; B23B 2231/2086; B23B 2231/0252

(57) ABSTRACT

An adjustable chuck apparatus is provided with a torque limiting device; a torque transmitting mechanism; a chuck; a threaded fastener; a pin; a first positioning member including a threaded tunnel; a second positioning member including a threaded tunnel; a barbell shaped interconnection member including a first externally threaded section at one end and threadedly fastened in the threaded tunnel of the first positioning member, a second externally threaded section at the other end and threadedly fastened in the threaded tunnel of the second positioning member, a bar interconnected to the first externally threaded section and the second externally threaded section, and a hole element through the second externally threaded section; a truncated conic collet; and a cap. Each of different screw taps can be fastened by the apparatus by rotating a hand tool to adjust a distance between the first positioning member and the second positioning member.

### BACKGROUND OF THE INVENTION

### 1. Field of the Invention

The invention relates to chucks and more particularly to an adjustable chuck apparatus for a screw tap, each of a plurality of different screw taps adapted to be fastened by the chuck apparatus by rotating a hand tool to adjust a distance between a first positioning member and a second positioning member.

### 2. Description of Related Art

Conventionally, one of a plurality of replaceable grasping ends (e.g., jaws) of a chuck for screw tap can be mounted with one of a plurality of screw taps having different sizes and types. Specifications of these different screw taps are specified in, for example, JIS of Japan, ISO of an international standards organization, DIN371 and DIN376 of German, and ANSI of US. The chuck can accommodate screw taps ranged from 3 mm to 12 mm with a total of 28 different specifications. Thus, a user has to buy a whole set of different jaws in order to accommodate different screw taps. However, it has the drawbacks of frequent replacements of different jaws in use, being time consuming, and being laborious.

Thus, the need for improvement still exists.

### SUMMARY OF THE INVENTION

It is therefore one object of the invention to provide an adjustable chuck apparatus for a screw tap comprising a torque limiting device including an inner grasping member, a positioning member, and a torque transmitting mechanism wherein the torque transmitting mechanism is disposed in the positioning member and passes through the inner grasping member, and the positioning member includes a projecting threaded shank configured to fasten in the inner grasping member; the torque transmitting mechanism including a projection, a cylindrical element spaced from the projection, a truncated conic member at one end of the projection distal the cylindrical element, and a hole through the truncated conic member; a chuck including a transverse channel, an externally threaded protrusion at one end, a truncated conic first hole through the externally threaded protrusion to communicate with the transverse channel, a second hole at the other end and communicating with the transverse channel, the second hole being shaped to complimentarily receive the truncated conic member, and a lateral first hole member extending from an outer surface to the transverse channel; a threaded fastener; a pin; a first positioning member including a threaded tunnel; a second positioning member including a threaded tunnel; a barbell shaped interconnection member including a first externally threaded section at one end and threadedly fastened in the threaded tunnel of the first positioning member, a second externally threaded section at the other end and threadedly fastened in the threaded tunnel of the second positioning member, an intermediate bar interconnected to the first externally threaded section and the second externally threaded section, and a hole element through the second externally threaded section; a truncated conic collet including a plurality of grasping elements arranged as a disc, each grasping member having two hole units on an inner surface and a trough between the hole units, a plurality of biasing members each biased between the adjacent hole units of two adjacent grasping elements, and a passage formed by the troughs; and a cap including an opening and a threaded inner surface; wherein the threaded fastener is driven through the first hole, the transverse channel, the second hole and the hole to secure to the torque transmitting mechanism, thereby fastening the chuck and the torque transmitting mechanism together; the interconnection member, secured to both the first positioning member and the second positioning member, is disposed in the transverse channel; the pin is inserted into the first hole member to urge against the intermediate bar; the collet is disposed in the threaded inner surface of the cap to urge against the opening of the cap; and the threaded inner surface of the cap is secured to the externally threaded protrusion to secure the cap and the chuck together.

Preferably, the torque transmitting mechanism further comprises a well on the truncated conic member; and wherein the chuck further comprises a lateral second hole member extending from an outer surface to the second hole, the second hole member being aligned with the well when the torque transmitting mechanism is disposed in the inner grasping member, and a key inserted through the second hole member into the well to hold the chuck and the torque transmitting mechanism together.

Preferably, the torque transmitting mechanism further comprises a plurality of spaced cavities on the cylindrical element, the cavities arranged as a ring and formed with the projection, a plurality of steel balls respectively disposed on the recesses, and a plurality of joining surfaces each between two adjacent cavities; further comprising a cup shaped anchoring member including a truncated conic inner surface urging against the steel balls; and a plurality of resilient rings disposed in the torque limiting device, the resilient rings being put on the projection and biased between the anchoring member and the inner grasping member.

Preferably, the torque transmitting mechanism further comprises a plurality of equally spaced recesses in an open end of the threaded shank, the recesses being adjacent to the cavities respectively.

Preferably, further comprises a sleeve put on the inner grasping member, and a biasing element biased by and between the inner grasping member and the sleeve.

Preferably, the collet complimentarily urges against the first hole.

The above and other objects, features and advantages of the invention will become apparent from the following detailed description taken with the accompanying drawings.

### BRIEF DESCRIPTION OF THE DRAWINGS

FIG. 1 is a perspective view of an adjustable chuck apparatus for screw tap according to the invention with a screw tap to be fastened therein;

FIG. 2 is an exploded view of the chuck apparatus;

FIG. 3 is an axial longitudinal sectional view of the chuck;

FIG. 4 is an axial longitudinal sectional view of the chuck apparatus;

FIG. 5 is a view similar to FIG. 4 showing the screw tap fastened in the chuck apparatus and being worked;

FIG. 6 is a sectional view taken along line A-A of FIG. 5;

FIG. 7 is a sectional view taken along line B-B of FIG. 5;

FIG. 8 is an exploded view of the torque limiting device;

FIG. 8A is an enlarged view of the torque transmitting mechanism shown in FIG. 8;

FIG. 9 is a broken-away perspective view showing a rotational force being exerted on the torque limiting device;

FIG. 10 is a perspective view showing steel balls in cavities;

FIG. 11 is a view similar to FIG. 10 showing the steel balls removed from the cavities in operation;

FIG. 12 is an axial longitudinal sectional view of the torque limiting device showing the steel balls in the cavities;

FIG. 13 is a sectional view taken along line C-C of FIG. 12;

FIG. 14 is a view similar to FIG. 12 showing the steel balls removed from the cavities in operation; and

FIG. 15 is a sectional view taken along line D-D of FIG. 14.

### DETAILED DESCRIPTION OF THE INVENTION

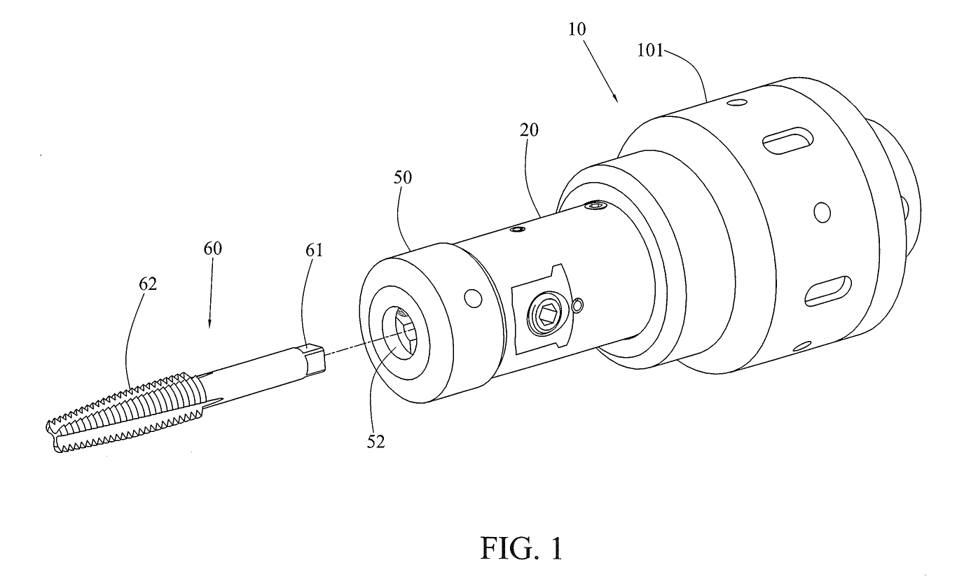

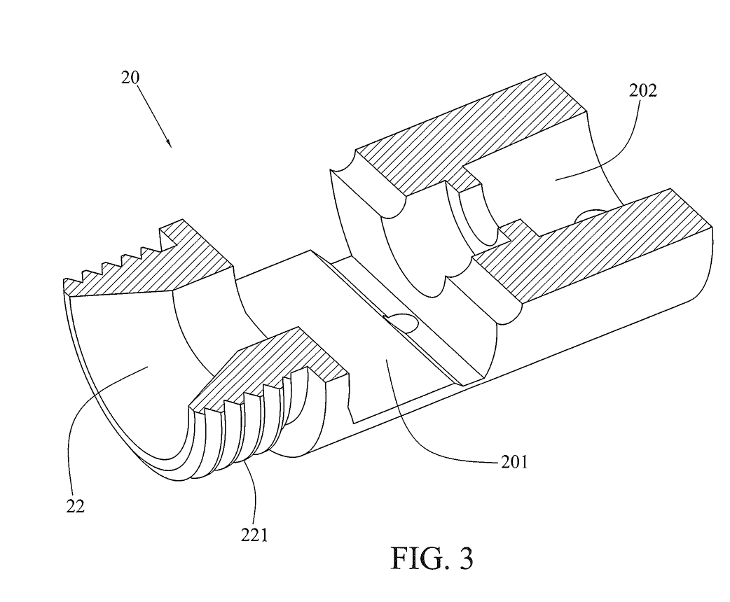

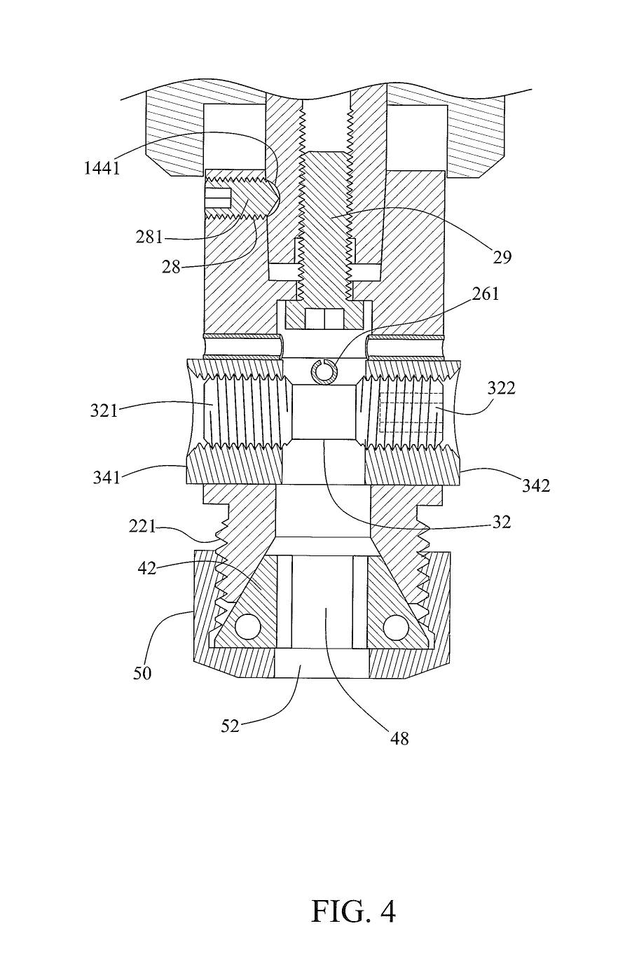

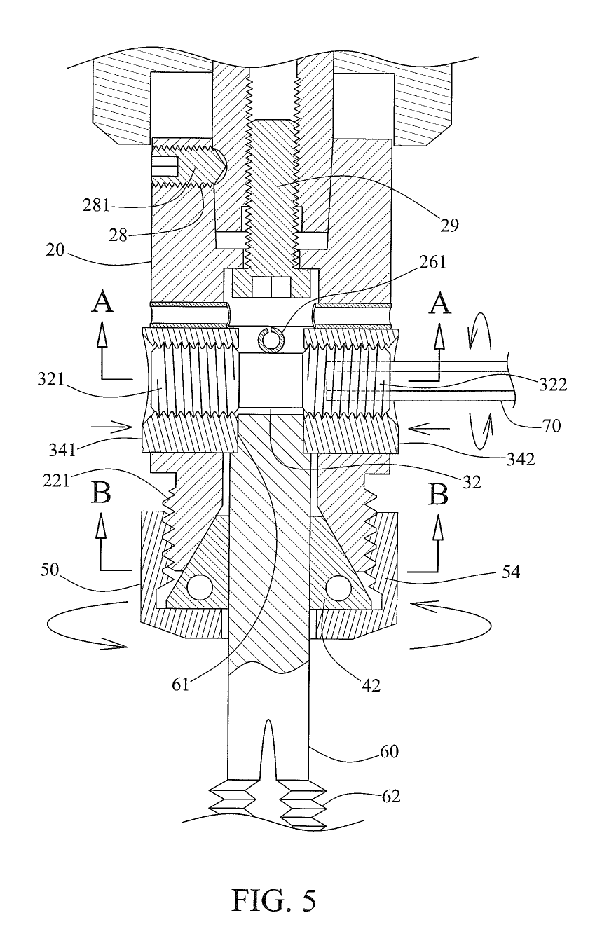

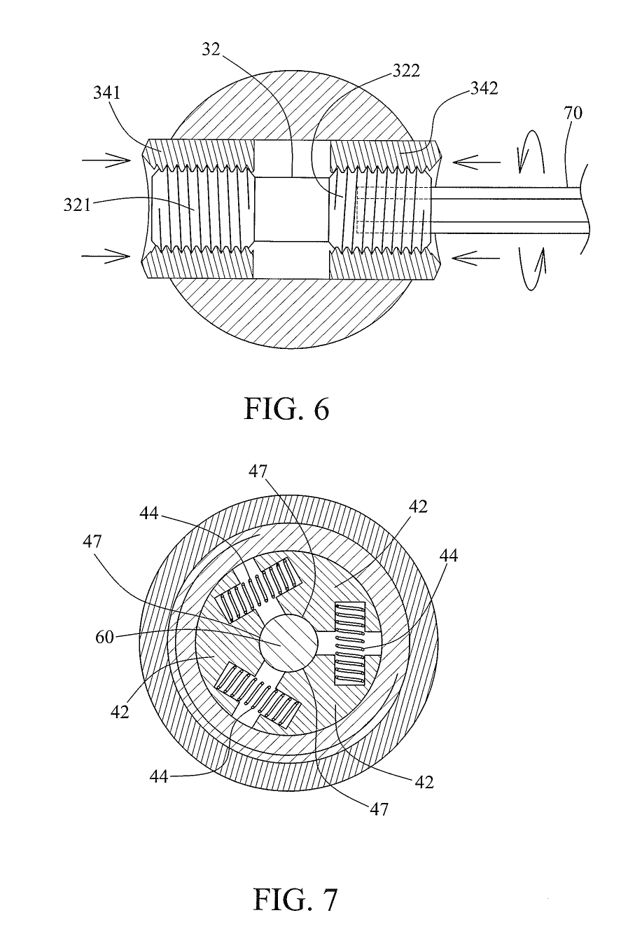

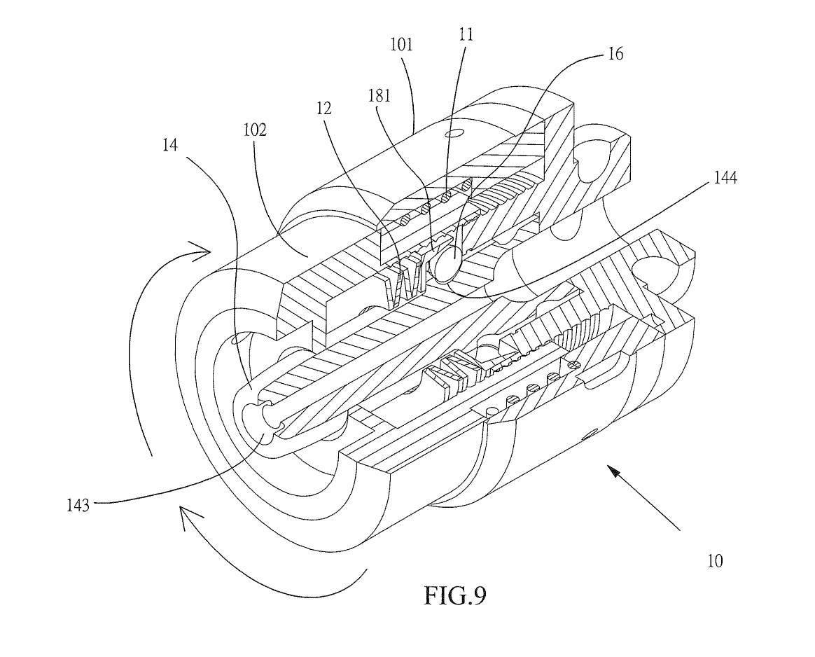

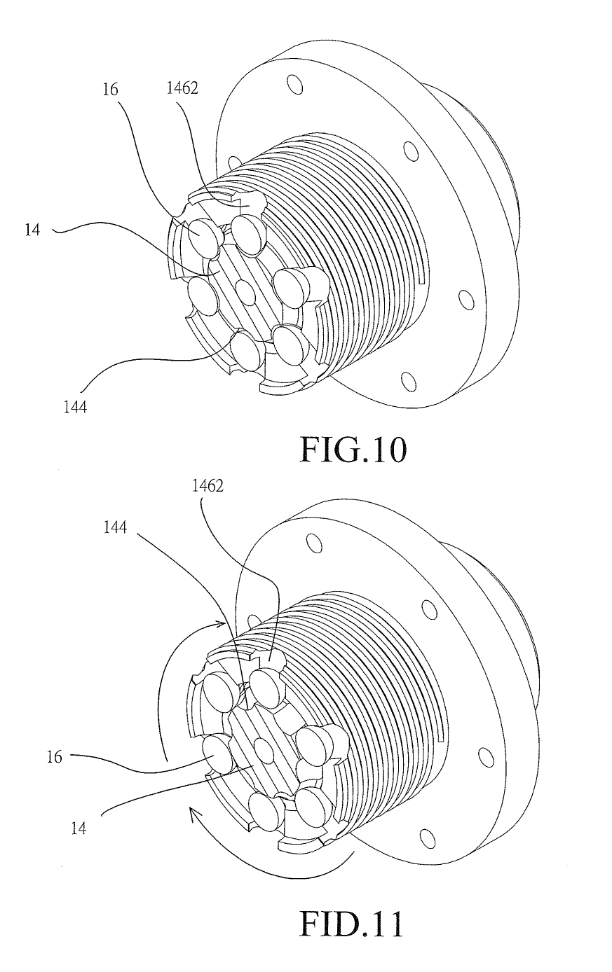

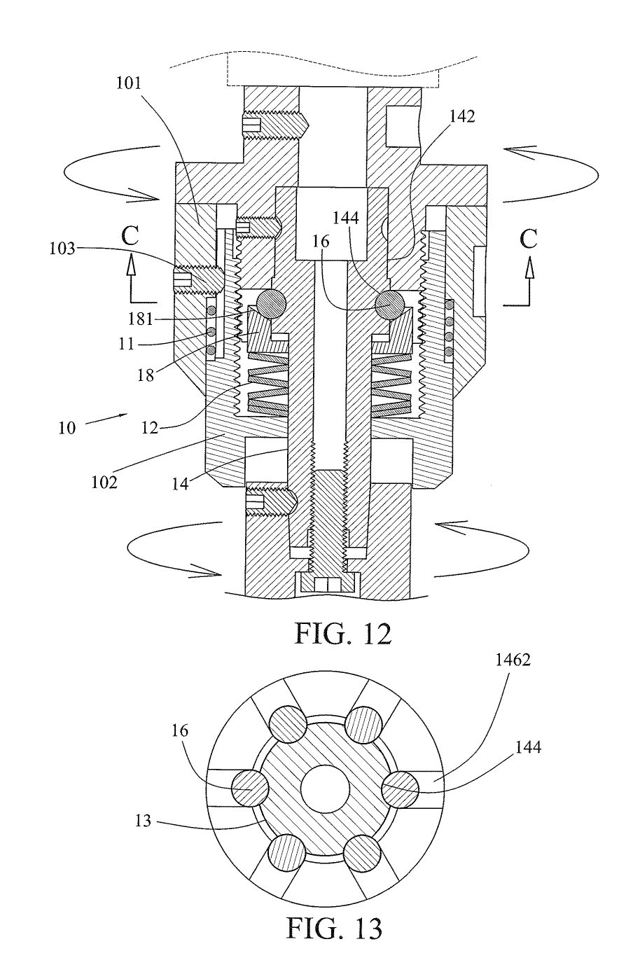

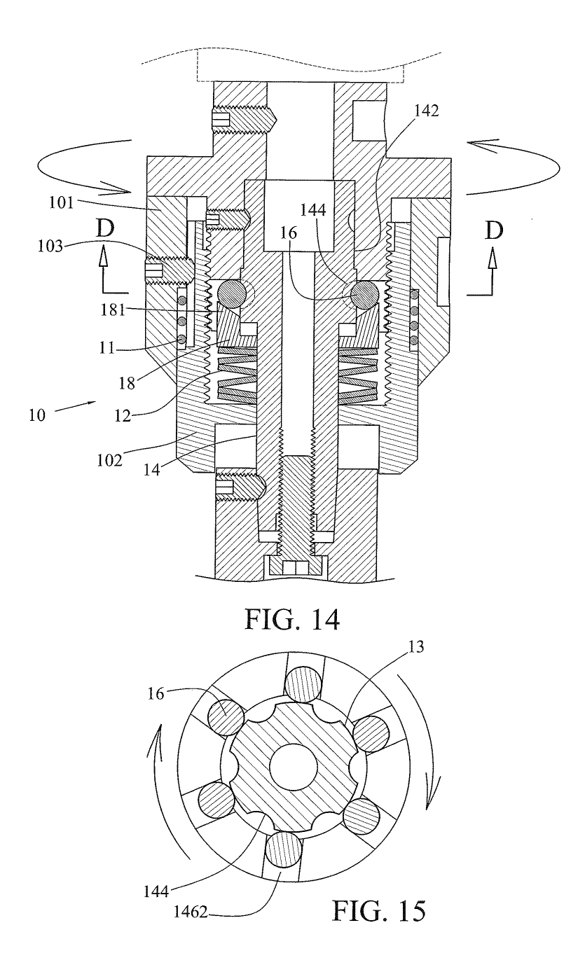

Referring to FIGS. 1 to 15, an adjustable chuck apparatus for screw tap in accordance with the invention comprises the following components as discussed in detail below.

A torque limiting device 10 includes an inner grasping member 102, a positioning member 146, and a torque transmitting mechanism 14 disposed in the positioning member 146 and through the inner grasping member 102. The positioning member 146 includes a projecting threaded shank 1461 configured to fasten in the inner grasping member 102, and a plurality of equally spaced recesses 1462 in an open end of the threaded shank 1461. The internally threaded torque transmitting mechanism 14 includes a cylindrical projection 141, a cylindrical element 142 spaced from the projection 141, a truncated conic member 145 at one end of the projection 141 distal the cylindrical element 142, a well 1441 on the truncated conic member 145, a hole 143 through the truncated conic member 145, the projection 141, and the cylindrical element 142, a plurality of spaced cavities 144 arranged as a ring and interconnected to the cylindrical element 142 and the projection 141, the cavities 144 being adjacent to the recesses 1462 respectively, and a plurality of joining surfaces 13 each between two adjacent cavities 144.

A chuck 20 includes an intermediate transverse channel 201, an externally threaded protrusion 221 at one end, a truncated conic first hole 22 through the protrusion 221 to communicate with the channel 201, a second hole 202 at the other end and communicating with the channel 201, the second hole 202 being shaped to complimentarily receive the truncated conic member 145, a lateral first hole member 26 extending from an outer surface to the channel 201, and a lateral second hole member 28 extending from the outer surface to the second hole 202. A threaded fastener 29, a pin 261, a first positioning member 341 having a threaded tunnel 3411, a second positioning member 342 having a threaded tunnel 3421 are provided.

A barbell shaped interconnection member 30 includes a first externally threaded section 321 at one end and threadedly fastened in the threaded tunnel 3411, a second externally threaded section 322 at the other end and threadedly fastened in the threaded tunnel 3421, an intermediate bar 32 interconnected to the first externally threaded section 321 and the second externally threaded section 322, and a hole 323 through the second externally threaded section 322. A collet 40 includes three grasping elements 42 arranged as a disc, each grasping member 42 having two holes 46 on an inner surface and a trough 47 between the holes 46, and three torsion springs 44 each biased between the adjacent holes 46 of two adjacent grasping elements 42. The three troughs 47 and gaps each between two adjacent grasping elements 42 form a passage 48. The collet 40 is shaped as a truncated cone.

A cup shaped cap 50 includes an opening 52 and a threaded inner surface 54. The threaded fastener 29 is driven through the first hole 22, the channel 201, the second hole 202 and the hole 143 to secure to the threads of the internally threaded torque transmitting mechanism 14. Thus, the chuck 20 and the torque transmitting mechanism 14 are secured together. The interconnection member 30, secured to both the first positioning member 341 and the second positioning member 342, is disposed in the channel 201. The pin 261 is inserted into the first hole member 26 to urge against the bar 32. The collet 40 is disposed in the inner surface 54 and urging against the opening 52. The threaded inner surface 54 is threadedly secured to the externally threaded protrusion 221 to secure the cap 50 and the chuck 20 together with the collet 40 complimentarily urging against the first hole 22.

The well 1441 is aligned with the second hole member 28 when the torque transmitting mechanism 14 is disposed in the inner grasping member 102. A key 281 is inserted through the second hole member 28 into the well 1441 to hold the chuck 20 and the torque transmitting mechanism 14 together. A plurality of steel balls 16 are respectively positioned in both the cavities 144 and the recesses 1462. A hollow, cup shaped anchoring member 18 includes a truncated conic inner surface 181 urging against the steel balls 16. A plurality of resilient rings 12 are provided in the torque limiting device 10. The resilient rings 12 are put on the projection 141 and biased between the anchoring member 18 and the inner grasping member 102. A sleeve 101 is put on the inner grasping member 102. A torsion spring 11 is biased by and between the inner grasping member 102 and the sleeve 101.

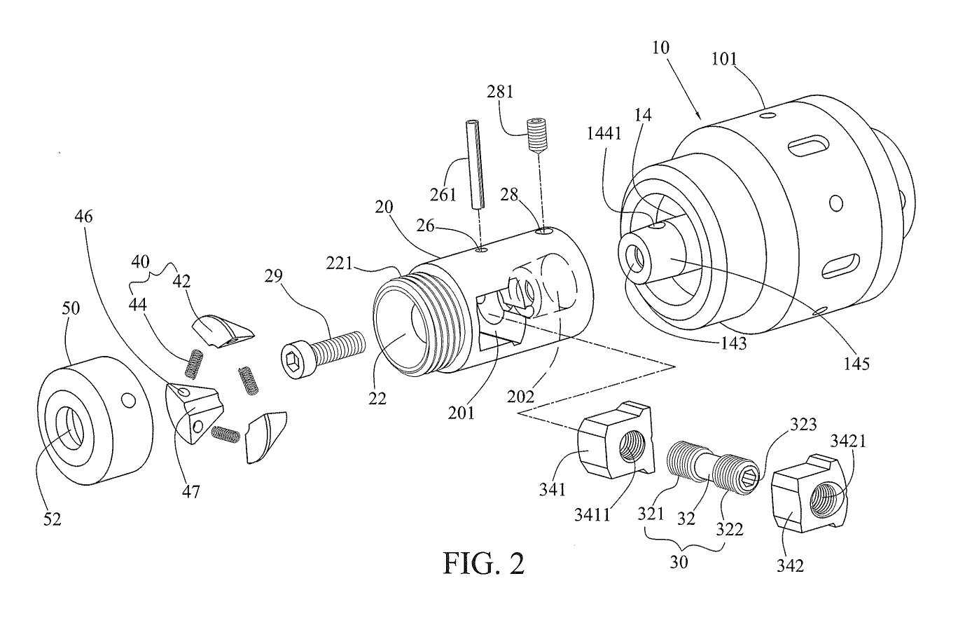

As shown in FIGS. 2 and 5 to 7 specifically, in a rotational operation for adjusting a distance between the first positioning member 341 and the second positioning member 342, an individual may insert a hand tool 70 into the hole 323 and rotate the hand tool 70. And in turn, the first positioning member 341 may rotate on the first externally threaded section 321 and the second positioning member 342 may rotate on the second externally threaded section 322 both in the same direction. For example, a clockwise rotation of the hand tool 70 may decrease the distance and a counterclockwise rotation of the hand tool 70 may increase the distance. As a result, the distance between the first positioning member 341 and the second positioning member 342 is changed. The adjustment of the distance is ended when the distance is sufficient to fasten a projecting end 61 of a screw tap 60 which is inserted through the opening 52 of the cap 50 and the passage 48. The screw tap 60 further includes an externally threaded drilling portion 62 at the other end. It is envisaged by the invention that each of a plurality of different screw taps 60 can be fastened by the adjustable chuck apparatus by making above adjustment.

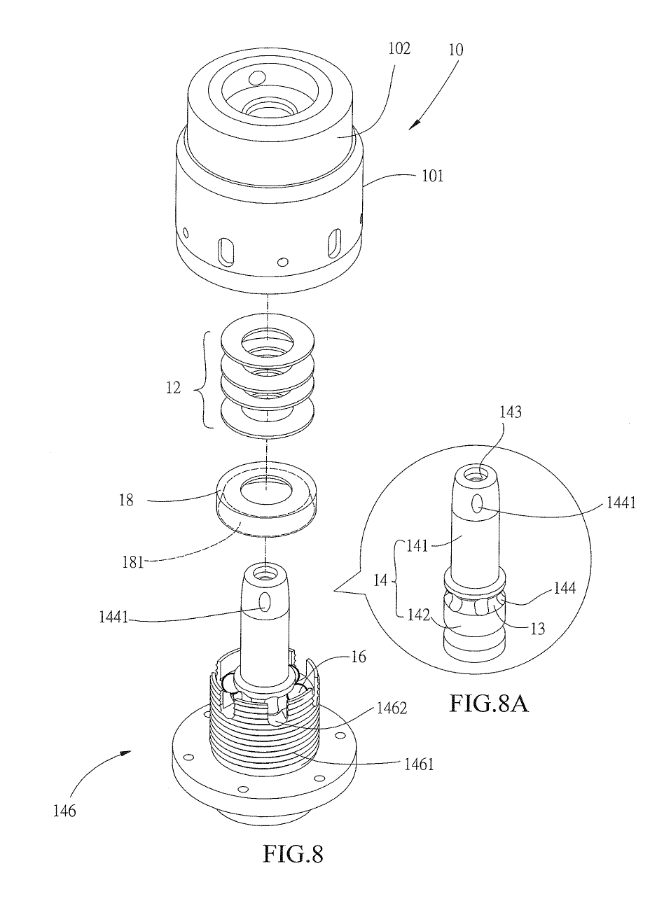

As shown in FIGS. 8 to 10, 12 and 13 specifically, initially, the steel balls 16 are anchored in the cavities 144. The sleeve 101 may be rotated in response to rotating the torque limiting device 10. And in turn, the inner grasping member 102 rotates accordingly due to the provision of another key 103, which is inserted through the sleeve 101 to abut upon the outer surface of the inner grasping member 102. Further, the steel balls 16 are removed from the cavities 144 and the recesses 1462 to dispose on the joining surfaces 13 due to centrifugal force of the rotating inner grasping member 102. Furthermore, the inner surface 181 of the anchoring member 18 is pressed by the resilient rings 12 to urge the inner surface 181 against the steel balls 16. And in turn, the torque transmitting mechanism 14 rotates to rotate the screw tap 60. As a result, the drilling portion 62 may perform a drilling operation on a work piece.

As shown in FIGS. 8, 9, 11, 14 and 15 specifically, the drilling operation may be stopped when the drilling portion 62 is jammed in the work piece. Next, the steel balls 16 move from the joining surfaces 13 to the cavities 144 and the recesses 1462 due to the stop of the centrifugal force. Further, the inner grasping member 102 urges against the inner surface 181 to push the anchoring member 18 toward the resilient rings 12. The steel balls 16 rotate in the cavities 144 in situ. While the torque limiting device 10 rotates, the torque transmitting mechanism 14 stops rotation because rotational force is not transmitted to the torque transmitting mechanism 14. As a result, the screw tap 60 stops rotation. This can prevent the drilling portion 62 from being damaged due to excessive torque.

While the invention has been described in terms of preferred embodiments, those skilled in the art will recognize that the invention can be practiced with modifications within the spirit and scope of the appended claims.

What is claimed is:

1. An adjustable chuck apparatus for a screw tap comprising:
a torque limiting device including an inner grasping member, a positioning member, and a torque transmitting mechanism wherein the torque transmitting mechanism is disposed in the positioning member and passes through the inner grasping member, and the positioning member includes a projecting threaded shank configured to fasten in the inner grasping member;
the torque transmitting mechanism including a projection, a cylindrical element spaced from the projection, a truncated conic member at one end of the projection distal the cylindrical element, and a hole through the truncated conic member;
a chuck including a transverse channel, an externally threaded protrusion at one end, a truncated conic first hole through the externally threaded protrusion to communicate with the transverse channel, a second hole at the other end and communicating with the transverse channel, the second hole being shaped to complimentarily receive the truncated conic member, and a lateral first hole member extending from an outer surface to the transverse channel;
a threaded fastener;
a pin;
a first positioning member including a threaded tunnel;
a second positioning member including a threaded tunnel;
a barbell shaped interconnection member including a first externally threaded section at one end and threadedly fastened in the threaded tunnel of the first positioning member, a second externally threaded section at the other end and threadedly fastened in the threaded tunnel of the second positioning member, an intermediate bar interconnected to the first externally threaded section and the second externally threaded section, and a hole element through the second externally threaded section;
a truncated conic collet including a plurality of grasping elements arranged as a disc, each grasping member having two hole units on an inner surface and a trough between the hole units, a plurality of biasing members each biased between the adjacent hole units of two adjacent grasping elements, and a passage formed by the troughs; and
a cap including an opening and a threaded inner surface;
wherein the threaded fastener is driven through the first hole, the transverse channel, the second hole and the hole to secure to the torque transmitting mechanism, thereby fastening the chuck and the torque transmitting mechanism together;
the interconnection member, secured to both the first positioning member and the second positioning member, is disposed in the transverse channel;
the pin is inserted into the first hole member to urge against the intermediate bar;
the collet is disposed in the threaded inner surface of the cap to urge against the opening of the cap; and
the threaded inner surface of the cap is secured to the externally threaded protrusion to secure the cap and the chuck together.

2. The adjustable chuck apparatus for a screw tap of claim 1, wherein the torque transmitting mechanism further comprises a well on the truncated conic member; and wherein the chuck further comprises a lateral second hole member extending from an outer surface to the second hole, the second hole member being aligned with the well when the torque transmitting mechanism is disposed in the inner grasping member, and a key inserted through the second hole member into the well to hold the chuck and the torque transmitting mechanism together.

3. The adjustable chuck apparatus for a screw tap of claim 1, wherein the torque transmitting mechanism further comprises a plurality of spaced cavities on the cylindrical element, the cavities arranged as a ring and formed with the projection, a plurality of steel balls respectively disposed on the recesses, and a plurality of joining surfaces each between two adjacent cavities; further comprising a cup shaped anchoring member including a truncated conic inner surface urging against the steel balls; and a plurality of resilient rings disposed in the torque limiting device, the resilient rings being put on the projection and biased between the anchoring member and the inner grasping member.

4. The adjustable chuck apparatus for a screw tap of claim 3, wherein the torque transmitting mechanism further comprises a plurality of equally spaced recesses in an open end of the threaded shank, the recesses being adjacent to the cavities respectively.

5. The adjustable chuck apparatus for a screw tap of claim 1, further comprising a sleeve put on the inner grasping member, and a biasing element biased by and between the inner grasping member and the sleeve.

6. The adjustable chuck apparatus for a screw tap of claim 1, wherein the collet complimentarily urges against the first hole.
